(19) United States
(12) Patent Application Publication
(10) Pub. No.: US 2007/0291601 A1
(43) Pub. Date: Dec. 20, 2007

(54) METHOD OF CORRECTING CHROMATIC ABERRATION GENERATED DURING CONVERSION FROM REPRODUCING MODE TO RECORDING MODE, AND RECORDING METHOD AND RECORDING AND REPRODUCING APPARATUS ADOPTING THE CORRECTION METHOD

(75) Inventors: Woo-seok CHOI, Seoul (KR); Tae-kyung Kim, Seoul (KR); In-joo Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/685,390

(22) Filed: Mar. 13, 2007

(30) Foreign Application Priority Data
Jun. 14, 2006 (LR) 2006-53549

(51) Int. Cl. G11B 7/00

(52) U.S. Cl. 369/44.29; 369/44.27

(57) ABSTRACT

A chromatic aberration correcting method to correct chromatic aberration generated during a conversion from a reproducing mode to a recording mode in an optical recording and reproducing apparatus which uses an optical pickup to form a light spot on an optical information storage medium by focusing light emitted from a light source using an objective lens and to detect light reflected from the optical information storage medium using a photodetector includes applying a focus offset to the objective lens before the conversion from the reproducing mode to the recording mode to reduce defocus caused by chromatic aberration generated according to the change in wavelength generated when an output light power of the light source is changed from a reproducing light power to a recording light power, and correcting the defocus by outputting the recording light power from the light source during the conversion to the recording mode while the focus offset is applied to the objective lens.

### CROSS-REFERENCE TO RELATED APPLICATION

This application claims the benefit of Korean Application No. 2006-53549, filed Jun. 14, 2006, in the Korean Intellectual Property Office, the disclosure of which is incorporated herein by reference.

### BACKGROUND OF THE INVENTION

1. Field of the Invention

Aspects of the present invention relate to a method of correcting chromatic aberration generated due to a change in wavelength according to a change in output power of a light source during conversion from a reproducing mode to a recording mode by controlling an objective lens in an optical pickup for recording and an optical recording and reproducing apparatus having the optical pickup, and a recording method and a recording and reproducing apparatus adopting the correction method.

2. Description of the Related Art

An optical pickup for focusing light at an optical disc includes a laser diode to emit a laser beam, a collimating lens to concentrate the light output from the laser diode to make a parallel beam, and an objective lens to focus the parallel beam passing through the collimating lens on the optical disc. To remove chromatic aberration, a method of compensating for chromatic aberration of the objective lens with the chromatic aberration of the collimating lens is generally used. A collimating lens is generally formed as either two or more units of lenses, or an entire surface diffractive lens.

Since the storage density of an optical disc increases as the size of an optical spot decreases, and since the size of the optical spot is proportional to a value of λ/NA, where λ is a wavelength of a light source and NA is a numerical aperture of an objective lens, a light source having a short wavelength and an objective lens having a high NA value are desired to record and reproduce information onto recently developed high density optical discs. For example, for the specification of a blu-ray disc (BD), a blue laser diode having a 405 nm wavelength and an objective lens having an NA value of 0.85 is used.

However, as the wavelength of a laser beam decreases and the NA value of an objective lens increases, an optical system becomes unreliable at various aberrations. Typically, a chromatic aberration, which is an aberration generated by a change in wavelength of a laser diode, is a direct cause of a defocus error during recording.

In a general optical disc, the light power required during recording is much higher than the light power required during reproducing. Also, in a general laser diode (LD), as the output power increases, the wavelength of an output light is characteristically increased. Thus, at the moment when the operation of an optical recording and reproducing apparatus is converted from reproduction to recording, the change of a few nanometers of the wavelength occurs and a focal length changes according to the dispersion of a material of the objective lens (generally, the focal length is elongated). Thus, as shown in FIG. 1, defocus offset is generated. Then, a focus servo of the optical pickup controls the objective lens to move the objective lens to an optimal focus position. However, defocus lasts for a response time Tr ranging from ten to several hundreds of microseconds (μs) until the objective lens is moved to the optimal focus position so that the size of the optical spot increases, and as a result, an error occurs in recording data.

FIG. 1 shows the generation of defocus offset at the moment of a reproducing-recording conversion. When the response time Tr passes after recording starts, the objective lens is located at the optimal focus position. In FIG. 1, “FES” indicates a focus error signal and “OL Position” indicates the position of the objective lens in relation to the optical disc.

To remove the defocus offset, a conventional method of removing chromatic aberration of an optical system is used. Specifically, to remove the chromatic aberration, a method of compensating for chromatic aberration of an objective lens using the chromatic aberration of a collimating lens is used. That is, the chromatic aberrations between the objective lens and the collimating lens are offset by making the chromatic aberration characteristic of the collimating lens opposed to that of the objective lens.

In order to embody such a collimating lens, it is known that either a lens group including a combination of two or more lens units, or a diffraction lens, may be used as the collimating lens. In the method using a combination of two or more lens units, the collimating lens is made of a group of a combination of two or more lens units, specifically, a combination of at least one lens having a positive (+) power and at least one lens having a negative (−) power, in which the at least one lens having a negative (−) power is made of a material having a relatively higher dispersion.

In the method of using a diffraction lens, the collimating lens is made into an aspheric single lens in which at least one surface of the collimating lens is made into an entire surface diffraction type so that the dispersion by the diffractive surface can offset the chromatic aberration of the objective lens. However, the method of offsetting the chromatic aberration of the objective lens by the chromatic aberration of the collimating lens group made of two or more lens units requires a lens assembly step and high lens manufacturing costs. Also, since the method using a group of two or more lens units has a limit in the range of correction of chromatic aberration, it is difficult to apply the method to an objective lens having a high NA value, such as an objective lens having an NA of 0.85 which is used with a BD.

Additionally, the method of using a diffraction lens is expensive due to the use of a diffractive device. Furthermore, a loss of light is unavoidable due to diffraction efficiency. In particular, since the characteristic of a diffraction lens surface varies greatly according to the wavelength incident on the diffraction lens, it is very difficult to use the method for an optical pickup compatible with optical discs requiring different wavelengths.

### SUMMARY OF THE INVENTION

To solve the above and/or other problems, aspects of the present invention provide a method of correcting chromatic aberration generated during conversion from a reproducing mode to a recording mode by controlling an objective lens to remove an effect of defocus offset caused by chromatic aberration due to a change in wavelength of a laser diode occurring during the conversion from a reproducing mode to a recording mode in an optical pickup for an optical recording and reproducing apparatus, and a recording method and a recording and reproducing apparatus adopting the correction method.

Additional aspects and/or advantages of the invention will be set forth in part in the description which follows and, in part, will be obvious from the description, or may be learned by practice of the invention.

According to an aspect of the present invention, a method of correcting chromatic aberration generated during a conversion from a reproducing mode to a recording mode in an optical recording and reproducing apparatus having an optical pickup to focus light emitted from a light source on an optical information storage medium and to detect the light reflected from the optical information storage medium using a photodetector includes applying a focus offset to the objective lens before the conversion to reduce defocus caused by the chromatic aberration, and outputting recording light power from the light source during the conversion to the recording mode while the focus offset is applied to the objective lens.

According to another aspect of the present invention, a method of correcting chromatic aberration generated during the conversion from a reproducing mode to a recording mode in an optical recording and reproducing apparatus having an optical pickup to focus light emitted from a light source on an optical information storage medium by focusing light emitted from a light source using an objective lens and to detect the light reflected from the optical information storage medium using a photodetector includes applying a focus offset to the objective lens before the conversion to reduce defocus caused by the chromatic aberration, outputting recording light power from the light source during the conversion to the recording mode while the focus offset is applied to the objective lens, and recording information on the optical information storage medium.

The method according to another aspect of the present invention may further include removing the focus offset after the recording of the information starts.

According to another aspect of the present invention, an optical recording and reproducing apparatus having an optical pickup to focus light emitted from a light source on an optical information storage medium using an objective lens and to detect the light reflected from the optical information storage medium using a photodetector includes a control portion which controls the light source to output an appropriate light power according to a reproducing mode and a recording mode and which controls an application of a focus offset to the objective lens, wherein the control portion corrects defocus caused by chromatic aberration generated during a conversion from the reproducing mode to the recording mode by applying the focus offset to the objective lens before the conversion.

The distance of the focus offset applied to the objective lens may be the same as a distance of the defocus.

The distance of the focus offset applied to the objective lens may be smaller than the distance of the defocus and a difference therebetween may be within a defocus error limit.

The time during which the focus offset is applied to the objective lens may correspond to a response speed required for an actuator to move the objective lens from a reproducing focus distance to a recording focus distance.

The amount of the focus offset applied to the objective lens may be controlled in proportion to the recording light power.

The optical information storage medium may include a single information layer or a plurality of information storage layers located on a surface of the optical information storage medium.

The optical information storage medium may be a blu-ray disc (BD) or a high definition (HD) DVD having a single information storage layer or a plurality of information storage layers located on a surface of the optical information storage medium.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the generation of defocus offset during a conversion from a reproducing mode to a recording mode when a general optical pickup is used;

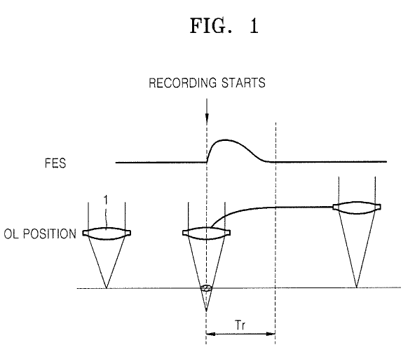

FIG. 2 is a conceptual diagram of a chromatic aberration correcting and recording method according to an embodiment of the present invention;

FIG. 3 is a conceptual diagram of a chromatic aberration correcting and recording method according to another embodiment of the present invention;

FIGS. 4A and 4B are plot images respectively showing the shakiness of FES at a recording moment of a BD-RE single layer (SL) optical disc and a BD-RE dual layer (DL) optical disc before the method of FIG. 2 is applied;

FIGS. 5A and 5B are images respectively showing the reproducing RF signals when the chromatic aberration is not corrected and when the chromatic aberration is corrected for recording of an SL optical disc;

FIGS. 6A and 6B are images respectively showing the reproducing RF signals when the chromatic aberration is not corrected and when the chromatic aberration is corrected for recording of a DL optical disc;

FIG. 7 is a plot image showing the shakiness of an FES at a recording moment of the DL BD-RE optical disc when the method of FIG. 3 is applied;

FIG. 8 schematically illustrates the structure of the entire system of an optical recording and reproducing apparatus adopting the chromatic aberration correcting and recording method according to an aspect of the present invention; and

FIG. 9 illustrates an example of an optical pickup which can be used for the optical recording and reproducing apparatus of FIG. 8.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are to remove a defocus effect due to the change in wavelength of a light source during recording by forcibly defocusing an objective lens for a particular time before the output power of a light source, for example, a laser diode LD, is increased to an output power used in a recording mode, during the conversion from reproducing to recording of information (data), in an optical pickup of an optical recording and reproducing apparatus.

When the optical pickup is converted from a reproducing mode to a recording mode, optical output is radically increased so that the output wavelength of the LD changes. Accordingly, as a focal length changes according to the chromatic aberration of an objective lens, a defocus error is generated. The defocus error causes a focus error signal. A focus servo is then operated to reduce the defocus error by moving an objective lens to focus the light beam at an optimal light spot. However, a recording characteristic is deteriorated for a time Tr that is needed for the process of focusing the light beam at an optimal light spot. The time Tr when the focus servo is optimized again is primarily determined by a response time of an actuator that drives the objective lens.

When recording starts in a state where a focus offset is already applied to the objective lens to fully offset the amount of defocus that is generated due to the change in wavelength, the optimal light spot can be obtained at the time when the recording starts, and thus, the recording performance is not deteriorated. Since the objective lens is already located at the optimal focus position when the focus offset is removed after the recording starts, the recording can be performed without shakiness while the optical light spot is maintained in a focus direction.

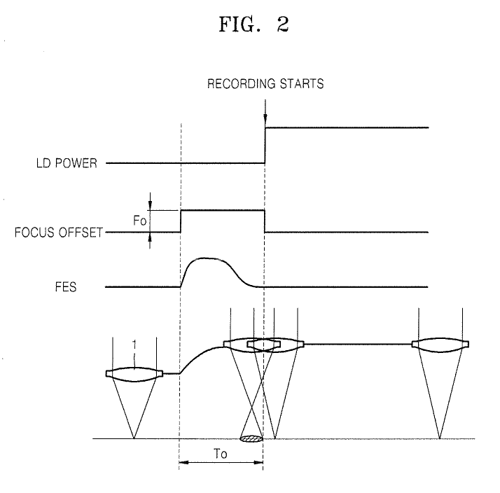

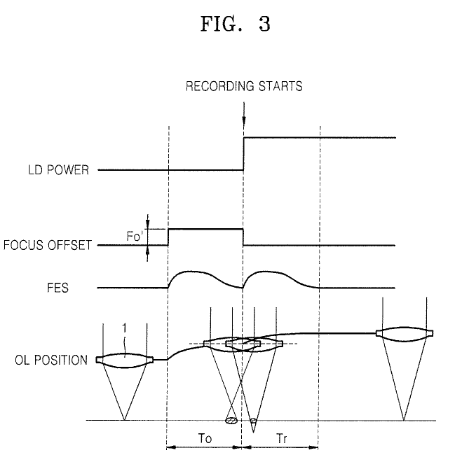

FIG. 2 is a conceptual diagram of a chromatic aberration correcting and recording method according to an embodiment of the present invention. FIG. 3 is a conceptual diagram of a chromatic aberration correcting and recording method according to another embodiment of the present invention. In FIGS. 2 and 3, “Fo” and “Fo′” refer to amounts, or distances, of focus offset, and “To” refers to a focus offset application time during which a defocus operation is performed before the recording starts.

Referring to FIGS. 2 and 3, prior to the increase of LD power for starting recording (i.e., prior to the conversion from a reproducing mode to a recording mode), focus offset is applied to an objective lens 1 in a direction to decrease defocus according to the chromatic aberration due to the change in wavelength that is generated when the output light power of a laser diode (not shown) is converted from a reproducing light power to a recording light power. Because the focus offset is being applied to the objective lens 1, the mode is converted to the recording mode and the laser diode outputs the recording light power. As a result, the defocus caused by the chromatic aberration generated during the conversion from the reproducing mode to the recording mode is in a corrected state, that is, the chromatic aberration is corrected, and data recording is performed as soon as the recording starts. Once the recording starts, the focus offset applied to the objective lens 1 can be removed. Even when the focus offset is removed, since the objective lens 1 is already located at the optimal focus position, recording can be performed while the optimal optical spot is maintained, without shakiness in the focus direction.

According to an embodiment of the present invention, as shown in FIG. 2, to remove defocus when the recording is performed, a focus offset (Fo) value is made to be the same value as the amount of defocus due to chromatic aberration. At this time, when the focus offset application time To is too short, defocus may be generated during the recording because the objective lens 1 is not sufficiently moved. Also, since a reproducing signal is deteriorated when the focus offset is applied before the recording mode begins, the time To during which focus offset is applied to the objective lens 1 is preferably set to be the same as or similar to a response speed time Tr of an actuator (not shown). This response speed time preferably represents a time required for the actuator to move the objective lens from a reproducing focus distance to a recording focus distance relative to the optical information storage medium.

A light beam focused by the objective lens of an optical pickup (not shown) has a beam waist at the focal point and a focal depth of λ/(NA)². The reproducing and recording characteristics are not severely deteriorated by a small amount of the defocus offset. The maximum defocus allowance limit is known to be ±λ(2NA²). According to the blu-ray (BD) optical disc standard in which the wavelength λ of a light source is 405 nm (λ=405 nm) and the NA of the objective lens is 0.85 (NA=0.85), λ/(2NA²) equals 0.28 μm (λ/(2NA²)=0.28 μm). That is, even when a small amount of defocus exists at the optimal focus at the moment of recording, if the amount of defocus is smaller than the maximum defocus allowance limit, recording performance is not deteriorated.

Thus, as shown in FIG. 3, it is possible to set the value of the focus offset Fo′ to be slightly smaller than the amount of defocus due to chromatic aberration. In this case, a focus error signal FES has two offset times, instead of the one offset time shown in FIG. 2, and the objective lens 1 is moved twice in the focus direction. It can be seen that the time required for the objective lens 1 to move from a recording start point to the optimal focus position in a stable fashion is much faster than the response speed time Tr of the actuator.

As described above, when the method for applying the focus offset to remove the defocus offset due to chromatic aberration according to another embodiment of the present invention is used, the reproducing performance may be deteriorated by defocus shortly before the recording. However, since an accurate reading of address signals is more important than a data reproducing performance shortly before converting to a recording mode, even when a reproducing signal is slightly deteriorated, an optical recording and reproducing apparatus still can sufficiently record and reproduce information from an optical disc when an address signal can be read. For example, for a recording BD in which the address signal is read by a wobble signal, it is sufficient that the wobble signal is accurately read even when data reproducing jitter is deteriorated by the defocus. Also, since the wobble signal of a BD is repeated, even when a wobble signal of a short length is lost, it is sufficient that a recording address can be accurately read. In other words, a recording operation does not experience problems when an effect of the defocus error shortly before the recording is managed within a level allowed by the system.

The recording light power required to record information onto an optical disc varies according to the type, recording speed, and number of recording layers of the optical disc. As the recording power increases, the change in wavelength of the light output from a laser diode increases, and the amount of defocus due to chromatic aberration correspondingly increases. Thus, the amounts Fo and Fo′ of the focus offset for the correction of chromatic aberration may be increased in proportion to the recording light power.

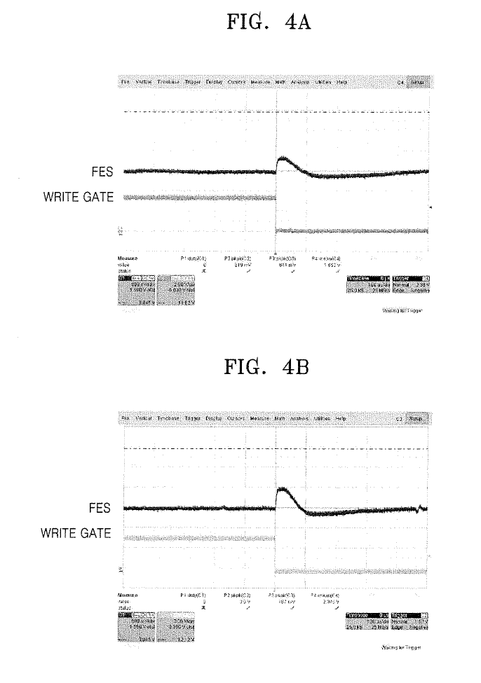

FIGS. 4A and 4B are plot images showing the shakiness of FES at a recording moment of each of a BD-RE single layer (SL) optical disc and a BD-RE dual layer (DL) optical disc before the method of FIG. 2 is applied. The BD-RE disc signifies a BD standard rewritable optical disc. FIG. 4A shows a BD-RE disc having a single information storage layer for a recording surface while FIG. 4B shows a BD-RE disc having a plurality of information storage layers, for example, two information storage layers, for a recording surface. In FIGS. 4A and 4B, a section in the horizontal direction signifies a time period of 100 μs, and a section in the vertical direction signifies a voltage of 500 mV for an FES. A write gate signal uses a voltage of approximately 2.00 V. Also, in FIGS. 4A and 4B, a write gate signal is a digital signal signifying reproducing and recording operations when the write gate signal is high and low, respectively.

As shown in FIGS. 4A and 4B, when the reproducing mode is converted to the recording mode, the focus error signal FES is shaken. This is because a defocus error is generated due to chromatic aberration. It can be seen that the FES stabilizes after about 100 μs. The stabilization time Tr is determined by the response characteristic of the actuator and is not related to the type of optical disc used with the recording and reproducing apparatus. Thus, in this case, the time To to which defocus is applied to correct chromatic aberration in the optical pickup is set to 100 μs, regardless of the type of optical disc used.

In FIGS. 4A and 4B, a degree of shakiness of the focus error signal FES is about 0.3 V for the SL optical disc and about 0.5 V for the DL optical disc. The degree of shakiness of the FES is proportional to the magnitude of the defocus. In this case, the peak to peak value (PP) of an S-curve generated during a focusing operation of the objective lens of the optical pickup is 1.2 V.

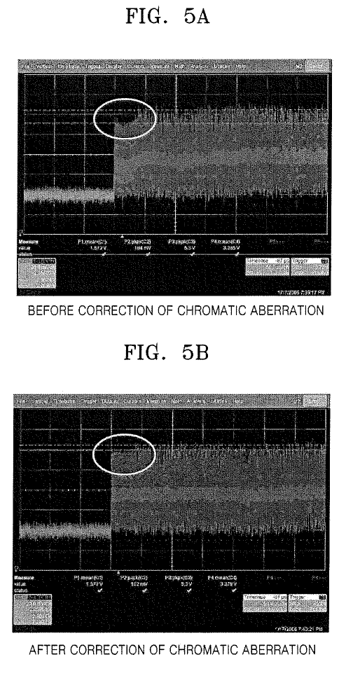

FIGS. 5A and 5B are images respectively showing the reproduced RF signal when the chromatic aberration is not corrected and when the chromatic aberration is corrected, for recording of an SL optical disc. FIG. 5A shows a reproduced RF signal before the correction of chromatic aberration and FIG. 5B shows a reproduced RF signal after the correction of chromatic aberration. As shown in FIG. 5A, the signal in an area of about 50 μs after recording starts is slightly unclear before the correction of chromatic aberration, and then the signal becomes clear after the correction of chromatic aberration. The result shown in FIG. 5B is obtained by applying a focus offset of 0.2 V for 100 μs before the recording operation to correct chromatic aberration, according to an aspect of the present invention. As shown in FIG. 5B, the signal at the moment recording starts is very clear.

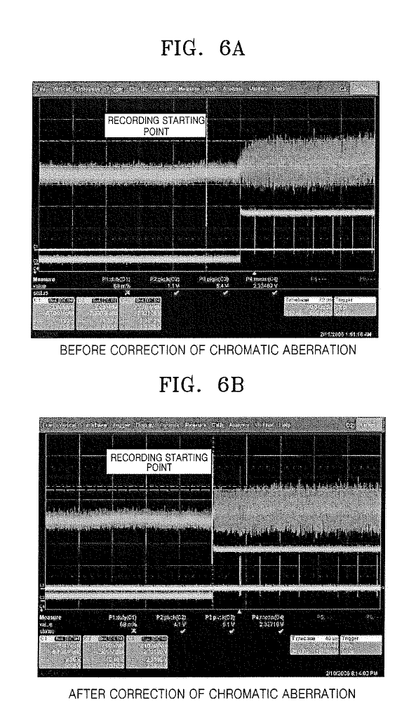

FIGS. 6A and 6B are images respectively showing the reproduced RF signal before and after the chromatic aberration is corrected during recording of a DL optical disc. FIG. 6A shows a reproduced RF signal before the correction of chromatic aberration and FIG. 6B shows a reproduced RF signal after the correction of chromatic aberration. As shown in FIGS. 6A and 6B, for a DL optical disc, unlike the SL optical disc shown in FIGS. 5A and 5B, data is not recorded at all in an area of about 50 μs after the recording before the correction of chromatic aberration, then data is partially recorded for 20 μs, and then data is normally recorded 70 μs after recording starts. In contrast, when a focus offset of 0.25 V is applied for a time period of 100 μs before the recording for the correction of chromatic aberration according to an aspect of the invention, as shown in FIG. 6B, it can be seen that a recording signal is normally reproduced.

As shown by the comparison between FIGS. 5A and 5B, as well as the comparison between FIGS. 6A and 6B, and in particular, for the DL optical disc, when the correction of chromatic aberration is not performed, a loss occurs in the recording signal, so that data recording cannot be efficiently performed without performing the correction of chromatic aberration. The reason for the generation of a serious problem in the DL optical disc, unlike the SL optical disc, is because the recording power required to record information onto the DL optical disc is about twice of the power required to record information onto the SL optical disc. Since the change in wavelength increases in proportion to the magnitude of the light power, chromatic aberration accordingly becomes more severe when the DL optical disc, which requires more recording power, is used.

As shown in FIGS. 5A, 5B, 6A and 6B, the chromatic aberration correcting and recording method according to aspects of the present invention can be applied when information recording is performed by converting a reproducing mode to a recording mode for various types of optical discs, such as an optical disc having a single information storage layer on a surface, for example, an SL BD-RE, or an optical disc having a dual information storage layer on a surface, for example, a DL BD-RE. It is understood that the chromatic aberration correcting and recording method according to aspects of the present invention can be applied to optical discs other than an SL BD-RE disc and a DL BD-RE disc, such as, for example, a conventional DVD and/or a CD. Aspects of the present invention produce beneficial results for many types of optical discs, and particularly produce beneficial results for discs which require a relatively high amount of recording power, such as the DL optical disc.

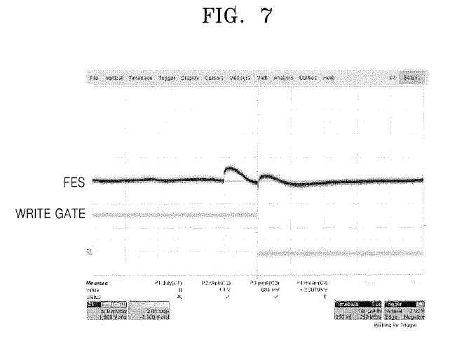

FIG. 7 is a plot image showing the shakiness of a focus error signal (FES) at the moment of conversion between reproducing and recording modes of the DL BD-RE optical disc when the method of FIG. 3 is applied. In FIG. 7, a section in the horizontal direction signifies a time period of 100 μs, and a section in the vertical direction signifies a voltage of 500 mV for an FES. A write gate signal uses a voltage of approximately 2.00 V.

FIG. 7 shows an FES at the moment of conversion between recording and reproducing modes when the chromatic aberration is corrected by applying a focus offset of 0.25 V for 100 μs to the DL optical disc. As shown in FIG. 3, the defocus is applied before recording and a defocus is generated by the effect of remaining chromatic aberration shortly after the recording so that the FES is shaken again. It can be seen that the amount of shakiness of the FES due to the chromatic aberration is 0.1 V after recording starts, which is about ⅕ of the shakiness of the FES generated before the correction of chromatic aberration of the DL BD-RE optical disc shown in FIG. 4A.

Thus, when the method of FIG. 3 is applied, the chromatic aberration during the conversion from a reproducing mode to a recording mode can be corrected for the DL optical disc and the recording signal can be normally recorded as soon as the recording starts.

Although in the above description the chromatic aberration correction method according to aspects of the present invention is applied during the conversion from a reproducing mode to a recording mode for a BD, which requires a light beam having a 405 nm wavelength, the above description is only intended to be exemplary. Aspects of the present invention can be applied to a variety of optical information storage media using light beams having a range of wavelengths, because chromatic aberration is still generated and still affects recording during the conversion from a reproducing mode to a recording mode. For example, an aspect of the present invention can be applied during the recording of information onto an HD (high definition) DVD using a blue light, for example, a light beam having a 405 nm wavelength. Also, aspects of the present invention can be applied to a variety of optical information storage media having different specifications using a light beam having a short wavelength such as a BD or HD DVD.

As described above, by applying the chromatic aberration correcting and recording method according to aspects of the present invention, the defocus error generated by the chromatic aberration due to a change in the wavelength of a laser diode during recording using an optical pickup for recording is removed to improve the recording performance of the optical pickup.

Specifically, since chromatic aberration can be corrected by controlling the objective lens without adding or deforming optical parts to correct chromatic aberration, unlike the conventional technology, aspects of the present invention reduce manufacturing costs, minimize a loss of light, and enhance optical efficiency. Also, for an optical pickup which is compatible with two or more wavelengths, it is advantageous that a compatible pickup can be easily made because of a little change in optical characteristics such as a focal length according to the two or more wavelengths.

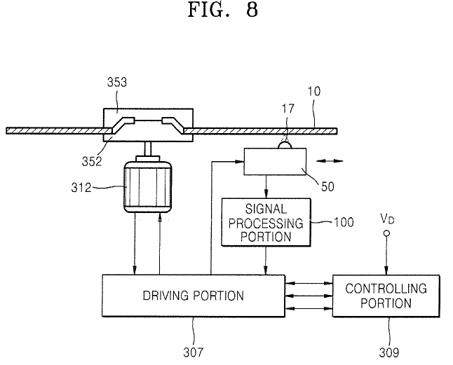

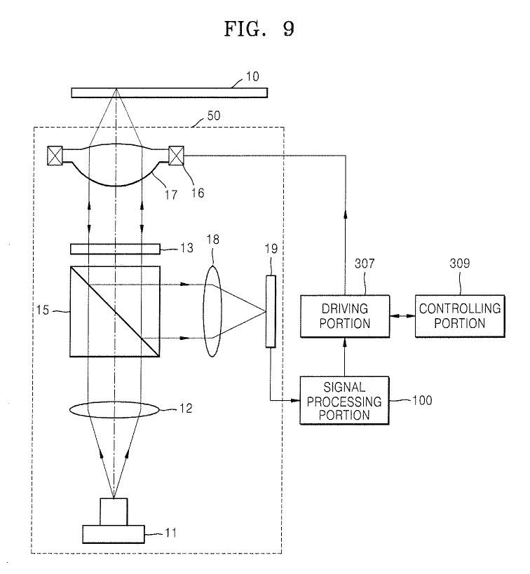

FIG. 8 schematically illustrates the structure of the entire system of an optical recording and reproducing apparatus adopting the chromatic aberration correcting and recording method according to an aspect of the present invention. FIG. 9 illustrates an example of an optical pickup which can be used with the optical recording and reproducing apparatus of FIG. 8.

Referring to FIG. 8, an optical recording and reproducing apparatus includes a spindle motor 312 to rotate an optical disc 10, an optical pickup 50 movably installed in a radial direction of the optical disc 10 to reproduce and record information from and to the optical disc 10, a signal processing portion 100 to detect a focus error signal from a detection signal of the optical pickup 50, a driving portion 307 to drive the spindle motor 312 and the optical pickup 50, and a controlling portion 309 to control the focus and tracking servo of the optical pickup 50. Also, the optical recording and reproducing apparatus further includes a turntable 352 and a clamp 353 to chuck the optical disc 10.

Referring to FIG. 9, the optical pickup 50 includes a light source, for example, a laser diode, an objective lens 17 to focus incident light on the optical disc 10, and a photodetector 19 to receive light that is reflected from the optical disc 10. Also, the optical pickup 50 includes an optical path changer 15, for example, a polarizing beam splitter, to change the proceeding path of incident light, a wavelength plate 13, for example, a quarter-wave plate, to change the polarization state of incident light, and a collimating lens 12 to correct incident light to have a parallel beam incident on the objective lens 17. The optical pickup 50 further includes a detection lens 18 that forms a light spot having an appropriate size for the photodetector 19 by focusing incident light. The detection lens 18 may be an astigmatism lens to detect a focus error signal in an astigmatism method. It is understood that other types of lenses and/or combination of lenses instead of an astigmatism lens may be used as the detection lens 18.

The optical disc 10 may be an optical disc, for example, a BD or HD-DVD, having a single or a plurality of information storage layers with respect to a surface of the optical disc. The light source 11 emits light having a predetermined wavelength appropriate for recording and reproducing of data to the optical disc 10. The light source 11 may emit a light beam having a blue wavelength, for example, a 405 nm wavelength, according to the BD and HD-DVD standard. It is understood that the light source 11 may also emit light beams having wavelengths larger or smaller than 405 nm, such as a red light beam used with a conventional DVD.

The objective lens 17 is driven in a focus direction by an actuator 16. The objective lens 17 can be formed to have an effective NA of 0.85 for a BD or 0.65 for an HD-DVD. Also, the objective lens 17 can be made to be compatible with the BD and HD-DVD by having effective NAs of 0.85 for a BD and 0.65 for an HD-DVD. The actuator 16 can drive the objective lens 17 to move in various directions, including a focus direction and a tracking direction. Additionally, the actuator 16 can drive the objective lens 17 in a tilt direction. Furthermore, the objective lens 17 is not required to be moved to achieve relative movement between the optical disc 10 and the objective lens 17. Instead, for example, the turntable 352 and the clamp 353 can move the optical disc 10 while the objective lens 17 remains in a fixed position. Alternatively, both the objective lens 17 and the optical disc 10 may be moved in combination with each other.

FIG. 9 shows an example of the optical configuration of the optical pickup 50 which can be used with the optical recording and reproducing apparatus shown in FIG. 8. The optical pickup 50 is a separation type optical system in which the light source 11 and the photodetector 19 are separated and the light source 11 and the photodetector 19 are provided by one for each. The light source 11 may emit a light beam having a single wavelength. The light source 11 may be a multi-type light source that emits a light beam having a plurality of wavelengths to compatibly adopt a DVD and at least one of a variety of multi-format optical discs, for example, a BD and an HD-DVD. The optical pickup 50 may further include a holographic optical module (not shown) to compatibly adopt the multi-format optical discs using light having different wavelengths. In addition, the optical configuration of the optical pickup 50 can be altered in diverse ways.

The light reflected from the optical disc 10 is changed to an electric signal by being detected and opto-electric converted by the photodetector 19 located on the optical pickup 50. The signal processing portion 100 receives the electric signal and generates a focus error signal FES. The FES is input to the control portion 309 through the driving portion 307. The signal processing portion 100 can detect a tracking error signal and/or a tilt signal from the electric signal output from the photodetector 19.

The driving portion 307 controls the rotation speed of the spindle motor 312, amplifies an input signal, and drives the optical pickup 50. The control portion 309 transmits focus servo, tracking servo, and/or tilt servo commands based on the signal output from the driving portion 307 to the driving portion 307 to perform focusing, tracking, and/or tilt operations of the optical pickup 50.

Also, the control portion 309 controls the light source 11 to output appropriate light power according to whether the reproducing and recording apparatus is functioning in a reproducing mode or a recording mode, and controls a signal for the defocus drive of the objective lens 17 to be applied to the actuator 16 to drive the whole bobbin (not shown) on which the objective lens 17 is mounted, or an additional actuator (not shown) directly driving the objective lens 17 only in the focus direction, so that focus offset is applied to the objective lens 17 through the driving portion 307 prior to the conversion to the recording mode. The recording and reproducing apparatus according to aspects of the present invention preferably, but not necessarily, has a structure such that the objective lens 17 is fixed to the bobbin and drives the bobbin with the objective lens 17 to apply focus offset to the objective lens 17 by applying a signal to drive the defocus of the objective lens 17 to the actuator 16. Alternatively, in the recording and reproducing apparatus, the objective lens 17 may be movably installed with respect to the bobbin and is connected to an additional actuator (not shown) to drive the objective lens 17 in the focus direction with respect to the bobbin, so that the focus offset can be applied to the objective lens 17 by directly driving the objective lens 17 only.

The amount of the focus offset being applied is controlled in proportion to the output light power of the light source 11. The focus offset is removed after a predetermined time during which the focus offset is applied.

As described above, by applying the chromatic aberration correcting and recording method according to aspects of the present invention during reproducing and recording by an optical pickup, the defocus error generated by the chromatic aberration caused by a change in wavelength of a laser diode is removed during recording, so that the recording performance of an optical pickup can be improved.

In particular, since the chromatic aberration is corrected by controlling the objective lens without adding or deforming optical parts to correct chromatic aberration, aspects of the present invention reduce manufacturing costs, minimize a loss of light, and enhance optical efficiency, compared to the conventional technology. Also, aspects of the present invention enable an optical pickup compatible with at least two wavelengths to be easily made because the change in optical characteristics such as the focal length according to the wavelength is little.

Aspects of the present invention can also be embodied as computer readable codes on a computer readable recording medium. For example, information about the type, recording speed, and number of recording layers of the optical disc may be stored as computer readable codes to automatically generate an appropriate focus offset value. The computer readable recording medium is any data storage device that can store data which can be thereafter read by a computer system. Examples of computer readable recording media include read-only memory (ROM), random-access memory (RAM), CD-ROMs, magnetic tapes, floppy disks, optical data storage devices, and a computer data signal embodied in a carrier wave comprising a compression source code segment and an encryption source code segment (such as data transmission through the internet). The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of correcting chromatic aberration generated during a conversion from a reproducing mode to a recording mode in an optical recording and reproducing apparatus having an optical pickup to focus light emitted from a light source on an optical information storage medium using an objective lens and to detect the light reflected from the optical information storage medium using a photodetector, the method comprising:
applying a focus offset to the objective lens before the conversion to reduce defocus caused by the chromatic aberration; and
correcting the defocus due to the chromatic aberration generated during the conversion to the recording mode by outputting recording light power from the light source during the conversion to the recording mode while the focus offset is applied to the objective lens.

2. The method of claim 1, wherein an amount of the focus offset applied to the objective lens is the same as an amount of the defocus.

3. The method of claim 1, wherein an amount of the focus offset applied to the objective lens is smaller than an amount of the defocus and a difference therebetween is within a defocus error limit during a recording operation.

4. The method of claim 2, wherein a time during which the focus offset is applied to the objective lens corresponds to a response time required for an actuator to move the objective lens.

5. The method of claim 1, wherein a time during which the focus offset is applied to the objective lens corresponds to a response time required for an actuator to move the objective lens.

6. The method of claim 1, wherein an amount of the focus offset applied to the objective lens is controlled in proportion to the recording light power.

7. The method of claim 6, wherein a time during which the focus offset is applied to the objective lens corresponds to a response time required for an actuator to move the objective lens.

8. An optical recording and reproducing apparatus having an optical pickup to focus light emitted from a light source on an optical information storage medium using an objective lens and to detect the light reflected from the optical information storage medium using a photodetector, the optical recording and reproducing apparatus comprising:
a control portion which controls the light source to output an appropriate light power according to a reproducing mode and a recording mode and which controls an application of a focus offset to the objective lens prior to conversion to the recording mode,
wherein the control portion corrects defocus caused by chromatic aberration generated during a conversion from the reproducing mode to the recording mode by applying the focus offset to the objective in a direction to reduce the defocus due to the chromatic aberration generated according to the change in wavelength generated when an output light power of the light source is changed from a reproducing light power to a recording light power.

9. The apparatus of claim 8, wherein an amount of the focus offset applied to the objective lens is the same as an amount of the defocus.

10. The apparatus of claim 8, wherein an amount of the focus offset applied to the objective lens is smaller than an amount of the defocus and a difference therebetween is within a defocus error limit during a recording operation.

11. The apparatus of claim 9, wherein a time during which the focus offset is applied to the objective lens corresponds to a response time required for an actuator to move the objective lens.

12. The apparatus of claim 8, wherein a time during which the focus offset is applied to the objective lens corresponds to a response time required for an actuator to move the objective lens.

13. The apparatus of claim 8, wherein an amount of the focus offset applied to the objective lens is controlled in proportion to the recording light power.

14. The apparatus of claim 13, further comprising an actuator, wherein a time during which the focus offset is applied to the objective lens corresponds to a response time required for the actuator to move the objective lens.

15. The apparatus of claim 8, wherein the optical information storage medium comprises one of a single information storage layer or a plurality of information storage layers located on a surface of the optical information storage medium.

16. The apparatus of claim 8, wherein the optical information storage medium comprises one of a blu-ray disc (BD) or a high definition (HD) DVD having a single information storage layer or a plurality of information storage layers located on a surface of the optical information storage medium.

17. A method of correcting chromatic aberration generated during a conversion from a reproducing mode to a recording mode in an optical recording and reproducing apparatus having an optical pickup to focus light emitted from a light source on an optical information storage medium using an objective lens and to detect the light reflected from the optical information storage medium using a photodetector, the method comprising:
adjusting a distance between the objective lens and the optical information storage medium before the conversion to offset the chromatic aberration; and
starting the conversion after the adjusting.

18. The method of claim 17, wherein the adjusting comprises increasing the distance between the objective lens and the optical information storage medium by a distance which is smaller than a defocus distance caused by the chromatic aberration and a difference therebetween is within a defocus error limit.

19. The method of claim 17, wherein the adjusting begins at a time before the conversion which corresponds to a response time required for an actuator to move the objective lens from a reproducing focus distance to a recording focus distance.

20. An optical recording and reproducing apparatus which corrects defocus caused by chromatic aberration generated during a conversion from a reproducing mode to a recording mode of an optical information storage medium, the optical recording and reproducing apparatus comprising:
an optical pickup having an objective lens which focuses light emitted from a light source to reproduce and record information from and to the optical information storage medium; and
a control portion which adjusts a distance between the objective lens and the optical information storage medium,
wherein the control portion corrects the defocus by adjusting the distance before the conversion starts to offset the defocus.
